(19) United States
(12) Patent Application Publication
(10) Pub. No.: US 2012/0031304 A1
(43) Pub. Date: Feb. 9, 2012

(54) LIPID-COATED METALLIC SULFATES COMPOSITIONS FOR REDUCING CATIONS IN CEMENT BASED COMPOSITIONS, AND RELATED METHODS

(76) Inventor: Fernando César Fernandes, Sao Paulo (BR)

(21) Appl. No.: 12/850,560

(22) Filed: Aug. 4, 2010

(51) Int. Cl. C04B 22/14; C09C 1/22; B05D 7/00; C04B 24/08

(52) U.S. Cl. 106/643; 106/661; 106/459; 106/460; 427/220

(57) ABSTRACT

A cement-based composition which comprises a mixture of a hyrdratable, cement-based composition and a compound comprising a metallic cationic species, the compound being in particulate form, the particles of the particulate compound having a lipid coating.

### BACKGROUND

The innovations described herein (“the inventive subject matter”) generally relate to lipid coated inorganic acidic materials, or their salts, containing sulfur in its anionic part as active ingredients for mortar, concrete, artificial stone or similar products, coated or impregnated with lipids, such as lard or tallow. More particularly, the inventive subject matter is directed to the use of lipid-coated, metallic sulfates, especially iron sulfate, as an additive in cement composition for the purpose of reducing cationic species in cement compositions, such as water-soluble, hexavalent Chromium (Cr (VI)).

The use of iron sulfate, whether coated or not, is known for several applications. Some examples of said applications include:

CA1145193, published on Apr. 26, 1983, refers to a food supplement for animals containing iron sulfate finely crushed with magnesium oxide using food lard or oil and another product to obtain an eatable mixture in the form of shaped blocks.

GB944331, published on Dec. 11, 1963, refers to a pharmaceutical preparation proper for composition of tablets and powder, including iron sulfate, coated with a lard composition, with a minimum melting point of 45° C., essentially composed of a mixture of saturated lard acids C 14-18 and from 0 to 11% of oleic and linoleic acids or their mixtures. The coating may be made by any process through which the iron compound is suspended in the melted lard composition, and the byproduct is subdivided and refrigerated.

GB267207, published on Mar. 7, 1927, presents improvements in relation to the manufacture of compositions containing coloring materials for carbon paper and typing-machine tape, with pigments being incorporated into oleaginous materials and precipitated in a diluted oleaginous dispersion. Materials that can be used include lard, oils and wax and a small quantity of a stabilizing agent added to the oleaginous dispersion. In the examples, a blue pigment is formed by the mixture of ferricyanide solutions and an iron salt with an aqueous emulsion of castor oil previously added to the solution. Dispersions of carnauba wax, bee wax, mineral oil, Vaseline or linseed oil can be used instead of castor oil.

The use of metallic sulfates, especially iron sulfate, as an additive for cement composition for the purpose of reducing the quantity of water-soluble CR (VI) is also known at the current state of the art.

Cement is a ceramic material which, in contact with water, produces an exothermal reaction of crystallization of hydrated products, thus reaching mechanical resistance. It is the most important material used in civil construction as a binder, both in concrete and mortar, and it is classified as hydraulic or non-hydraulic cement. Many of the hydraulic cements are based on Portland cement which, in simpler terms, is formed by limestone and clay minerals in high temperature processes in which they chemically react, generating new compounds. As used herein, the term “cement based” refers to hyrdratable compositions using cement as a binder, and cement-based compositions include pure cements, concretes, mortars, and grouts.

The cement composition, especially the hydraulic cement—Portland Cement, often contains soluble Cr (VI), usually in the form of chromate, in relatively large quantities, from 1 to 100 ppm, significantly above the maximum quantity permitted by the European Directive 2003/53/EC, which recommends up to 2 ppm. The soluble Cr (VI) causes dermal and allergic reaction, among other diseases, and for that reason the smallest quantity possible is recommended in these cements.

One of the manufacturing technologies of low Cr (VI) content cement involves the addition of iron sulfate in the cement grinding circuit for the purpose of reducing Cr (VI) ions by Fe (II) at the mill entrance for open-circuit mills, or at the separator entrance, for closed-circuit mills, or even in the finished product.

One of the main problems of adding iron sulfate to reduce chrome in cement is the loss of efficiency when exposed to air, due to the oxidation of Fe (II) to Fe (III). Disadvantageously, Fe (III) does not reduce Cr (VI), hence the need to use coated iron sulfate. For the same amount of chromium, it uses 90 times its weight of uncoated ferrous sulfate or 30 times its weight of coated iron sulphate.

For the aforementioned coating, the cement industry may use alginates or gelatin originated from the hydrolysis of collagen material, such as disclosed in WO2005048995, published on Jun. 2, 2005 and WO2008152521, published on Dec. 18, 2008. However, micro-particles of iron sulfate coated with these materials have an average diameter of 200 μm, which is more than the granulometry of the final product and, as a general rule, the coated iron sulfate is included in the process together with the raw materials grinding, which causes these micro-particles to be crushed, thus breaking the coating and exposing the iron sulfate to the air.

EP0160747, published on Nov. 13, 1985, discusses a dry cement composition with iron sulfate to eliminate or substantially reduce the content of water-soluble Cr (VI), produced by grinding raw materials in a cement plant. Iron sulfate, in quantities of 0.01 to 10% in weight, preferably 0.4%, is added to and mixed with the dry raw material. The iron sulfate used is a particulate material, the particles of which are supplied with a coating which prevents its oxidation. However, the coating of the iron sulfate is not specified. Iron sulfate is preferably added to raw materials prior to the cement mill.

EP1533287, published on May 25, 2005, discusses a liquid Cr (VI) reducer composition comprised of particles of solid material selected from the group composed of iron sulfate, tin sulfate, and the particles are substantially dispersed in a uniform manner inside a transporting liquid. Methods to modify hydratable cement materials using the chrome-reducing composition are also disclosed and suggest that they offer advantages in relation to compositions of dry or dissolved powder sulfate when used in cement manufacture.

WO2005048995, published on Jun. 2, 2005, discusses a method to produce iron sulfate as a food supplement which may also be used to reduce Cr (VI) in cements.

WO2008152521, published on Dec. 18, 2008, deals with a method to produce cement with a low content of soluble Cr (VI), which comprises the addition of iron sulfate articles coated with at least one byproduct of collagen hydrolysis, gelatin.

However, no reference found instructs or suggests application of metallic sulfates, especially iron sulfate, coated with lipids (e.g., lard or tallow) to reduce cationic species, such as Cr (VI) in cements.

Accordingly, there is a need for improved compositions of anionic species that are oxidatively stabilized by lipid coatings and provide reduction of undesirable cationic species in cement compositions.

### SUMMARY

The inventive subject matter generally addresses the aforementioned needs by providing composition and methods that reduce undesirable cationic species in cement compositions using oxidatively stabilized lipid-coated anionic species.

The inventive subject matter is particularly directed to reducing Cr (VI) species in compositions of cement mixture by using metallic sulfates, especially iron sulfate, with any level of hydration, coated with natural and/or synthetic lipids.

In certain embodiments, one solution for the aforementioned problem is the addition of metallic sulfates, especially iron sulfate, coated with animal-based lipids (e.g., lard or tallow), in compatible granulometry. The coated sulfates may admixed before or after grinding of the raw materials that comprise the cement, or they may be admixed to the final cement composition.

### DETAILED DESCRIPTION

Persons skilled in the art will recognize that many modifications and variations are possible in the details, materials, and arrangements of the parts and actions which have been described and illustrated in order to explain the nature of the inventive subject matter, and that such modifications and variations do not depart from the spirit and scope of the teachings and claims contained therein.

All patent and non-patent literature cited herein is hereby incorporated by references in its entirety for all purposes. While the principles of the inventive subject matter may be suitable for addressing a range of undesirable oxidized cationic species in cement compositions, as persons skilled in the art will appreciate from the teachings herein, the principles will be illustrated with respect the Cr(VI) as the undesirable cationic species. Similarly, a range of reducing agents may be used in accordance with the inventive subject matter. For example, in addition to iron as the metallic species, it is believed that other suitable metallic species include tin or manganese.

In certain embodiments, the inventive subject matter is designed to reduce the Cr (VI) reducing element in the composition of cement mixture by using iron sulfate coated with lipids Suitable lipids include lard and tallow. It is believed that other suitable lipids for coating iron or other metallic, cationic species include carnauba wax, bee wax, mineral oil, Vaseline gel, linseed oil, coconut oil, and/or palm oil. and preparation methods, preferably using iron sulfate in any level of hydration, coated with an appropriate amount of lipid, for example 1% to 6% weight percent of lipids (e.g., lard or tallow or any mixture thereof), preferably 3%, and minimum granulometry of 60%<100 μm and maximum granulometry of 20%>180 μm.

To illustrate one possible preparation method, a composition is prepared using a conventional pin mixer (constrict) into which iron sulfate with any level of hydration and an appropriate amount of lipids is placed. A suitable amount of lipids, in the case of tallow or lard, for example, is 1% to 6% weight percent. Preferably 3% of lipids (e.g., lard or tallow or any mixture thereof) are used with the iron sulfate. The mixture of the two raw materials is processed, and micro-particles of iron sulfate coated with lipids or tallow or their mixtures are obtained, which are mixed during the process of manufacturing hydraulic cement—Portland cement or mortar to comply with the maximum quantity of Cr (VI) permitted by regulatory rules, such as European Directive 2003/53/EC, which currently sets a limit of 2 PPM Cr(VI). The mixture is generally performed at room temperature and pressure, and the coated iron sulfate so obtained generally does not require any special packaging for commercialization.

Another option for preparing iron sulfate coated with lipids (e.g., lard or tallow or any mixture thereof) is the use of a mill, preferably a ball mill, in which the two materials are grinded until the desired granulometric range is reached. The coated iron sulfate so obtained does not require any special packaging. The grinding time depends on the desired granulometry and may vary from 10 to 60 minutes.

### EXAMPLES

Several tests were conducted varying the type of coating under several conditions, the characteristics of which are presented in Table 1.

TABLE 1
Coating characteristics, quantity of Fe (II)
(% weight) and residual Cr (VI) (ppm).

| | | Humidity | Fe (II) (%) | Cr (VI) |
|---|---|---|---|---|
| Test | Characteristics | (%) | weight | (ppm) |
| 1 | Ø < 100 μm + gelatin coating | 36.30 | 20.63 | 6.20 |
| 2 | Ø < 100 μm + T = 55° C. + | 36.10 | 19.79 | 7.00 |
| | gelatin coating | | | |
| 3 | Iron Sulfate (as it) | 20.60 | 24.41 | 7.10 |
| 4 | Ø < 100 μm + 5% of Lard | 17.00 | 23.63 | 0.21 |
| 5 | Ø < 100 μm + 5% of Lard | 16.00 | 23.57 | 0.22 |
| 6 | Ø < 100 μm + 5% of Lard + | 20.00 | 21.95 | 0.18 |
| | water | | | |
| 7 | Average production 3% of lard | 22.50 | 22.61 | 0.11 |
| 8 | Average production 3% of lard | 21.90 | 23.11 | 0.25 |
| 9 | Average production 3% of lard | 22.00 | 22.94 | 0.25 |

For tests 1 and 2, the coatings were performed as described in patent WO2008152521, and the coated grain had an average diameter of 200 μm. Test 3 used Fe (II) “as is” (with no coating) with an average granulometry of 200 μm for comparison purposes, and for tests 4 to a 9, Fe(II) was prepared with a lipid (lard) coating, according to the method proposed in the aforementioned patent, so that it had a minimum granulometry of 60%<100 μm and a maximum granulometry of 20%>180 μm. All tests had a lard coating with addition of water or not. Test 4 was conducted at laboratory level, test 5 corresponds to repetition of test 4 at industrial level to confirm the results, test 7 presents average results at pilot level, and tests 8 and 9 present average results in manufacturing plant.

Tests 2 and 3 show similar results, while test 1 presents slightly smaller results, although they do not meet the requirements of European Directive 2003/53/EC, and tests 4 to 9 show that coating iron sulfate with lard is more efficient in reducing Cr (VI), significantly exceeding the requirements of European Directive 2003/53/EC.

TABLE 2
Granulometric results obtained

| | Ø > 180 μm | Ø > 100 μm | Ø < 100 μm |
|---|---|---|---|
| Test | (%) | (%) | (%) |
| 1 | Not | Not | Not |
| | measured | measured | measured |
| 2 | 4 | 20 | 76 |
| 3 | 19 | 20 | 61 |
| 4 | Not | Not | 61 |
| | measured | measured | |
| 5 | Not | Not | 62 |
| | measured | measured | |
| 6 | Not | Not | 59 |
| | measured | measured | |
| 7 | 16 | 12 | 72 |
| 8 | 16 | 12 | 72 |
| 9 | 12 | 16 | 72 |

It is clear, from the results obtained, that tests 4 to 9 managed to reach the minimum of 60%<100 μm and the maximum of 20%>180 μm, which is sufficient for application of the product before or after grinding of the cement-forming raw materials. Test 2 showed the possibility of reaching this granulometry by grinding gelatin-coated iron sulfate, although the Cr (VI) reduction result was unsatisfactory. The granulometry of test 1 was not measured.

1. A cement-based composition, comprising a mixture of:
a hyrdratable, cement-based composition and a compound comprising a metallic cationic species, the compound being in particulate form, the particles of the particulate compound having a lipid coating.

2. The composition of claim 1 wherein the compound comprises iron sulfate having 1% to 6% (weight percent) of lipids.

3. The composition of claim 2 wherein the compound comprises iron sulfate having 3% of lipids.

4. The composition of claim 1 wherein the metallic species comprises iron sulfate.

5. The composition of claim 1 wherein the compound particles comprise lipid-coated iron sulfate particles having a granulometry lower than 200 μm.

6. The composition of claim 1 wherein the particles have a minimum granulometry of 60%<100 μm and a maximum granulometry of 20%>180 μm.

7. The composition of claim 5 wherein the particles have a minimum granulometry of 60%<100 μm and a maximum granulometry of 20%>180 μm.

8. The composition of claim 1 wherein the lipids comprise lard or tallow or any mixtures thereof.

9. The composition of claim 8 wherein the metallic species comprises Fe (II).

10. A method of making a coated compound, comprising:
providing iron sulfate providing a lipid; and
mixing the iron sulfate and lipid so as to produce coated iron sulfate particles.

11. The method of claim 10 wherein the lipid-coated iron sulfate is produced in a pin mixer (constrict) by mixing iron sulfate at any hydration level and at the desired granulometry, and 1% to 6% (weight percent) of lipids, carrying out the mixture of both raw materials at room temperature and pressure, and obtaining the coated iron sulfate which is mixed during the manufacture process of hydraulic cement.

12. The method of claim 10 wherein the coated iron sulfate is produced in a mill by the addition of iron sulfate at any granulometry and of 1% to 6% (weight percent) of lipids, with both materials being grinded until the desired granulometric range is reached within a grinding time depending on the desired granulometric range.

13. The method of claim 10 wherein the mixing occurs in a ball mill.

14. The method of claim 12 pursuant to claims no. 1 or 9, wherein the milling includes a grinding time of 10 to 60 minutes.

15. A particulate composition comprising particles of a compound comprising a metallic, cationic species coated with a lipid of 1%-6% (weight percent) of the compound, the particles having a granulometry lower than 200 μm.

16. The composition of claim 13 wherein the lipid comprises one or more of lard, tallow, carnauba wax, bee wax, mineral oil, Vaseline gel, linseed oil, coconut oil, and palm oil.

17. The composition of claim of claim 15 wherein the cationic species comprises iron, manganese, and/or tin.

18. The composition of claim 13 wherein the compound comprises iron sulfate.

19. The composition of claim 15 further comprising a composition having Cr(IV) species in an amount greater than 2 PPM.

20. The composition of claim 16 further comprising a composition having Cr(IV) species in an amount greater than 2 PPM, and wherein the cationic species comprises iron, manganese, and/or tin.
